(19) United States
(12) Patent Application Publication
(10) Pub. No.: US 2006/0106652 A1
(43) Pub. Date: May 18, 2006

(54) Graphic driven moving personal property tracking system and method

(76) Inventor: David A. Wamsley, Olympia, WA (US)

Correspondence Address: DEAN A. CRAINE, P.S., SUITE 140, 400 -112TH AVE NE, BELLEVUE, WA, 98004, US

(21) Appl. No.: 11/266,891

(22) Filed: Nov. 3, 2005

Related U.S. Application Data
(60) Provisional application No. 60/624,859, filed on Nov. 3, 2004.

(51) Int. Cl. G06Q 40/00; G09G 5/00

(52) U.S. Cl. 705/4; 345/661

(57) ABSTRACT

A graphic driven moving personal property tracking system that enables the company to monitor and track its customer's personal property during transport and to identify the various parties in the chain of custody. The system uses a hand held device that enables the packing company to accurately inventory and record the initial condition of the personal property prior to packing. Loaded into the memory of the hand held device is a building layout software program that visually presents images of different pieces of the personal property in selected rooms. When a room is selected, a list of personal property normally found in the room is presented. When damage is detected on the personal property prior to packing, the user selects the personal property and records precise location of the damage. When all of the personal property has been recorded, a written report is generated and delivered to the customer who then verifies the information. During the packing stage, an identifying code is assigned to each piece of personal property or to its outer container. When the personal property is moved between the hauling company, the warehouseman, and the unpacker, the handheld device is used to record the chain of custody and the condition of the property.

This is a utility patent application, which claims benefit of U.S. Provisional Application No. 60/624,859 filed on Nov. 3, 2004.

### BACKGROUND OF THE INVENTION

1. Field of the Invention

This invention pertains to systems and methods used to ship goods, and more particularly, to systems and methods used by a third party to ship goods owned by one party to another party that clearly identifies the goods and their initial condition, tracks the movement and condition of the goods during transport, and then identifies and marks their condition when they reach their final destination.

2. Description of the Related Art

Moving companies are commonly used to move the personal property of a family or business. It is also well known that during the move, the family's or business' personal property may be lost, stolen, and damaged by the employees or contractors involved in the moving process. Because different companies (i.e. packers, haulers, warehouseman) and individuals may be involved in the moving process, it is difficult for insurance companies who insure the companies involved in the move to determine if the damage or loss actually occurred during the move and, if so, which company is responsible. Because the records generated by the different companies are often missing or incomplete, the insurance companies are unable to refute a claim made by a customer or to identify the responsible company. As a result, the insurance companies allocated the loss to all the companies involved in the move, which eventually leads to higher insurance premiums for everyone.

One main obstacle that prevents the generation of complete and accurate moving records is that the forms used by companies must be manually completed. A typical form includes a general description an area where the description of the personal property is written. Adjacent to this general description area is a second area where visually defects or missing parts on the personal property are listed. These defects or missing parts are called ‘exceptions’ and are used to help establish the original condition of the personal property prior to taking under custody. On most forms, the general nature of the defect or missing part and its general location is denoted by a standardized code or abbreviation adopted by the industry which must be hand written onto the form. Unfortunately, these codes or abbreviations are not entered.

Each time a new company involved in the move takes custody of the personal property a form similar to the first form shown in FIG. 2 is completed. For example, when a packing company transfers custody of the personal property to a hauling company, the hauling company prepares and completes a second form. Later, when the hauling company transfers custody of the personal property to a warehouse for storage, a third form is completed. When the personal property is delivered to the final destination and unpacked, a fourth form is completed. For each form, the personal property must be accurately identified and listed and any new defects or shrinkage must be noted as an ‘exception’. Later, when a claim is made against one of the companies, an insurance claim adjuster collects all of the forms and then reviews them for the ‘exceptions’. When an ‘exceptions’ is found, the adjuster tries to determine which company had custody of the personal property just before the ‘exception’ was recorded. Unfortunately, because the forms are often lost or incomplete, the adjuster is unable to determine which company is responsible and then charges the lost to all of the companies involved in the move.

### SUMMARY OF THE INVENTION

It is an object of the present invention to provide a system for accurately and easily recording the initial condition of a customer's personal property by a moving company.

It is another object of the present invention to provide such a system that accurately monitors the existence and condition of the personal property each time the custody of the personal property changes during a move.

It is another object of the present invention to provide such a system that enables packers, haulers, and warehouseman to track the location of small components or hardware used with large personal property items during a move.

It is further object of the present invention to provide such a system that produces a final report for each personal property item moved that visually shows the original condition of the property, the condition of the property during intermediate stages of the move, and its final condition thereby enabling an insurance adjuster to determine the stage of the move when damage or lost occurred.

It is a still further object of the present invention to provide such a system that records the identity of the company or individual in custody during the stage when the personal property was damaged or lost.

These and other objects of the present invention are met by the graphic driven moving custody and tracking personal property tracking system disclosed herein designed to assist packing, hauling and warehouse companies to record and track personal property in their custody during a move. The system uses reports produced by different companies involved with the move at different stages that allows them to record the existence and condition of the personal property at different stages. Each personal property is tracked and its condition monitored at each stage of the move. When a lost or damage occurs to a personal property, a final report may be generated for the personal property by the insurance company that allows the insurance company to visually see the condition of the personal property at different stages and then determine which company had custody when the lost or damage occurred.

More specifically, a packing company, hereinafter called a packer, is hired by a customer to inventor and pack the customer's personal property to be moved. The customer releases the personal property to the packer who uses a handheld device to properly name and identify the personal property and to produce an identification label for each personal property or its outer container. During the initial inventory and packing stage, the packer also notes and records the initial condition of the personal property and other ancillary information, such other personal property, components or hardware associated therewith. Once the packing stage is completed, the information is then saved in the device's memory. An initial report may also be printed that is given to the customer.

If a separate hauler is hired to transport the personal property, the handheld device and a copy of the initial report is given to the hauler. The hauler reviews the personal property in the device and on the report, and records and exceptions. The exceptions noted by the hauler are recorded on in the handheld device. The hauler verifies its accuracy subject to the recorded exceptions. If exceptions are noted, a copy of the report is printed and given to the packer and the customer. Custody of the personal property is then transferred to the hauler.

The hauler remains responsible for the personal property until it is transferred to a warehouseman or released back to the customer. If the personal property is transferred to the warehouseman, the warehouseman inspects the personal property for losses and damages. If losses and damages are found they are recorded in the handheld device prior to accepting custody of the personal property. An intermediate report may be printed and give to the hauler. After storage, the personal property is usually transferred to another hauler who then delivers it to the customer and the final destination.

During each stage the presence and condition of the personal property is recorded in the handheld device. When a loss or damage to any item of personal property is found by the customer, a claim is submitted to the insurance company insuring all or some of the parties involved in the move. To allocate the loss to the responsible party, the insurance company reviews a final report generated by the handheld device. In the preferred embodiment, the final report includes graphic images of the personal property that indicated the entity who had custody of the personal property and its recorded condition. By during at what stage the condition of the personal property changed, the insurance company can easily determine which entity had custody and allocate the loss to that entity.

The system uses a portable handheld device used by the companies to accurately input the description of the personal property and record its condition to each stage. Loaded into the memory of the handheld device is an inventory identification and recording software program that helps the individuals name and identify personal property and associated components and hardware thereto, the names for certain types of damages, the severity of damages, and the precise location of damage on the personal property. In one embodiment, the software program provides the images of different buildings and their rooms commonly found in a move, and the names of personal property commonly found in the rooms.

In one embodiment, the software program presents a graphic image of the room and a graphic images of personal property set up therein. Common names are associated with the personal property. During use, the user simply presses against the handheld device's display to select a personal property item. The software program assigns an identifying code to the personal property with is printed on a label that can then be attached to the personal property or to its shipping container. Other indicia may be imprinted on the label to assist the moving entities.

When damage is detected on a item of personal property, the entity selects the personal property and is then shown a graphic image of it. A list of damage names and severity codes may be presented to the entity which are then selected. The entity then touches the display to indicate the precise location of the damage. If additional damage is found on the item of personal property, it is recorded in the same manner.

### DESCRIPTION OF THE DRAWINGS

FIG. 1 is an illustration of the handheld device being used to personal property and mark the condition of the goods to be shipped using the system disclosed therein.

FIG. 2 is a diagram of the system that shows a home or business customer with furniture or personal property to be moved hiring a packer, a moving company and an unpacking company used to move to furniture or personal property to a new location.

FIG. 3 is an illustration of the display on the hand held device showing the packer informing the device that he or she is located at the site of origin.

FIG. 4 is an illustration the user identification page presented on the display.

FIG. 5A is an illustration of a list of common rooms found in a house and presented on the display.

FIG. 5B is an illustration of a list of buildings produced and shown on the display/touch screen.

FIG. 6 is a perspective view of a bedroom filled with furniture presented on the display.

FIG. 7 is an illustration of a box selection page presented on the display that enables the packer to designate the type of box a piece of personal property's shipped in.

FIG. 8 is an illustration of a damage selection page presented to the packer, which allows the packer to designate the type of damage initially found on the invention and its relative location.

FIG. 9 is an illustration of a sheet quantity page presented to the packer that enables the packer to designate the number of sheets placed into a shipped container.

FIG. 10 is an identification tag produced by a printer coupled to the device that identifies the customer, the box number, and the list of personal property item inside the box.

FIG. 11 is an illustration of a typical closet showing the packer selecting a piece of clothing and indicating the type of box the piece of clothing is stored in.

FIG. 12 is an illustration of the display on the hand held device showing the hauler informing the device that he or she is located at the site of origin.

FIG. 13 is an illustration of a list of common rooms found in a house and presented on the display.

FIG. 14 is a perspective view of a bedroom filled with furniture presented on the display.

FIG. 15 is an illustration of the different kinds of dressers found in a bedroom.

FIG. 16 is an illustration showing the hauler designating the type of finish on the piece of furniture or the kind of material the piece is made of.

FIG. 17 is an illustration showing the hauler designating the type of damage on the piece of furniture and its precise location thereon.

FIG. 18 is an illustration of the display on the hand held device showing the warehouseman informing the device that he or she is an exception on transit.

FIG. 19 is an illustration showing the warehouseman using the device to check-in the inventory.

FIG. 20 is an illustration of a piece of furniture presented to the warehouseman showing the condition of the furniture and its precise location.

FIG. 21 is an illustration of the display page in which the customer uses the device to receive goods.

FIG. 22 is an illustration of a display page in which the customer selects the yellow personal property items.

FIG. 23 is an illustration of a display page showing the customer selecting a furniture number on a list of furniture numbers.

FIG. 24 is an illustration of a display page showing the piece of furniture that corresponds with the furniture number.

FIG. 25 is an illustration of the piece of furniture shown in FIG. 24 showing the customer recording new damage sites and their precise locations.

FIG. 26 is an illustration showing the condition of the piece of furniture at origin and the condition of the piece of furniture at destination.

FIG. 27 is a illustration of an identification label attached to an item of personal property.

FIG. 28 is a representative final report of item of personal property upon which a claim is submitted to the insurance company.

### DESCRIPTION OF THE PREFERRED EMBODIMENT(S)

Disclosed herein is a custody and tracking moving personal property system, generally denoted by the reference number 10, designed to assist insurance companies 90 for moving industry to accurately identify and hold liable companies designated 95 or individuals for lost or damage property. The system 10 is designed to product a final report 100 for each personal property inventoried which records its presence and physical condition at different stages or steps during the moving process. The information is collected contemporarily by the various individuals hired by the companies 95, 96, 97 directly involved in the moving process. When the moving process has completed a claim is made for loss or damages to the personal property, the final report may be used to easily at what stage the loss or damage occurred and the identify the responsible company or individual in custody of the personal property.

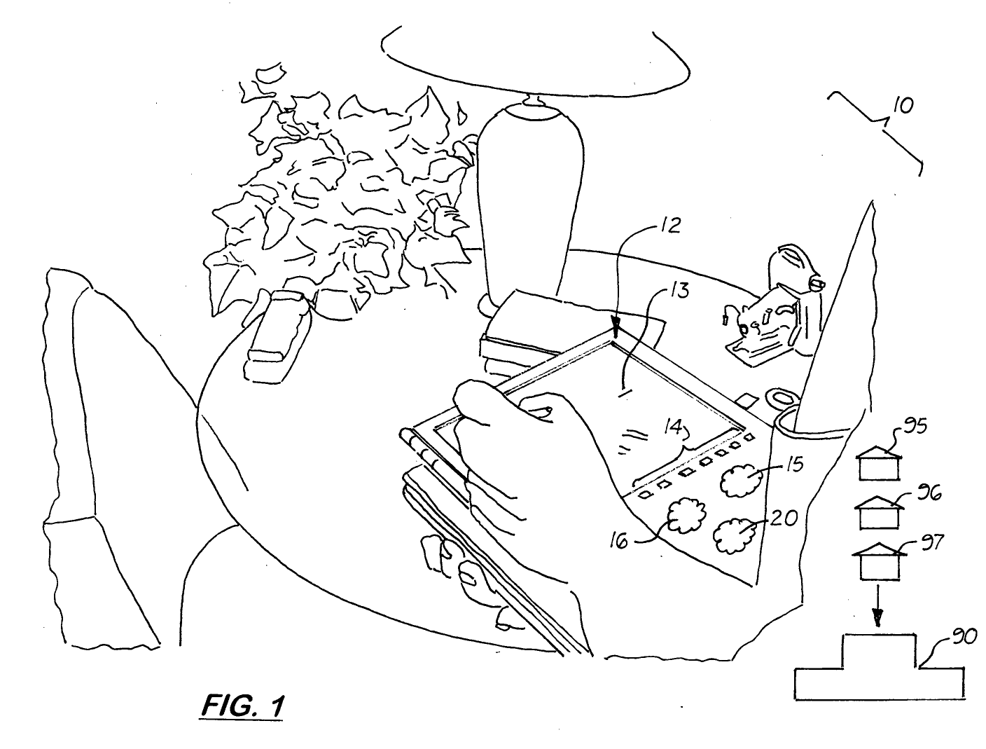

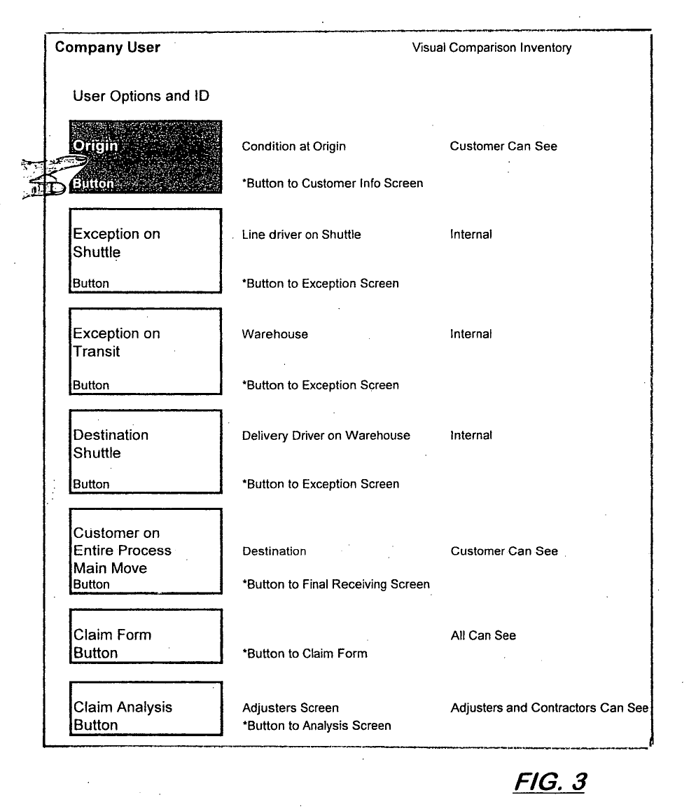

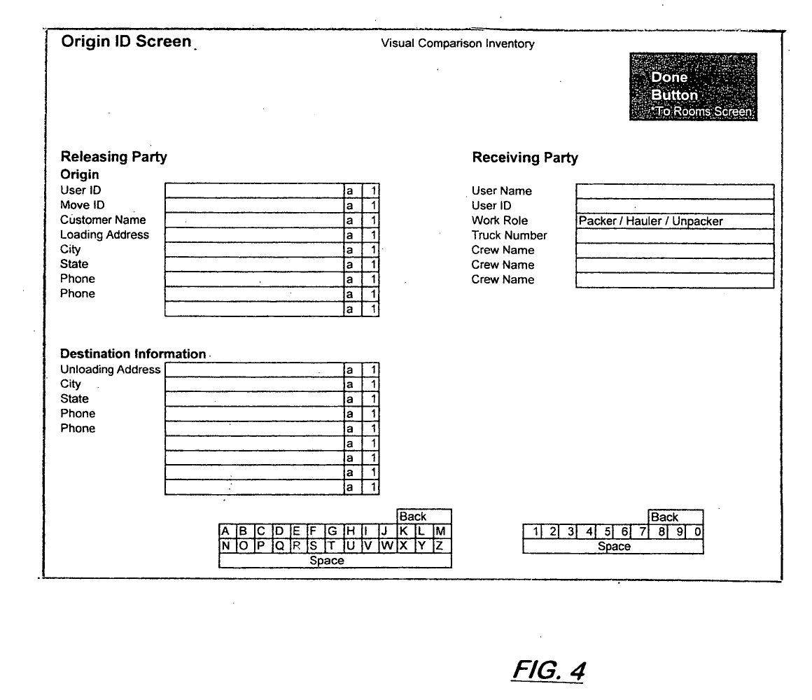

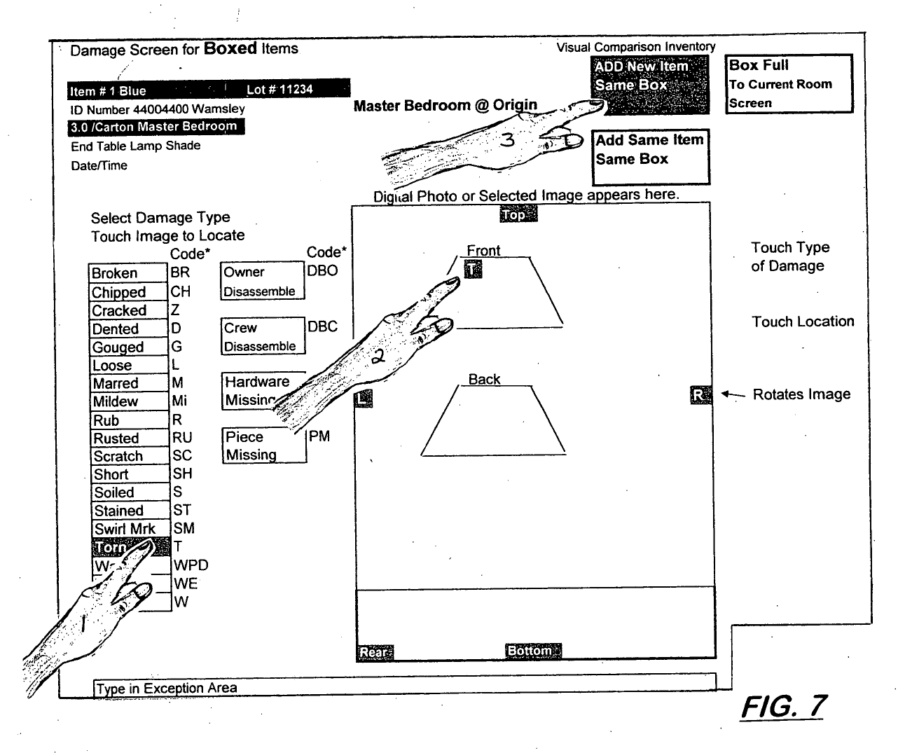

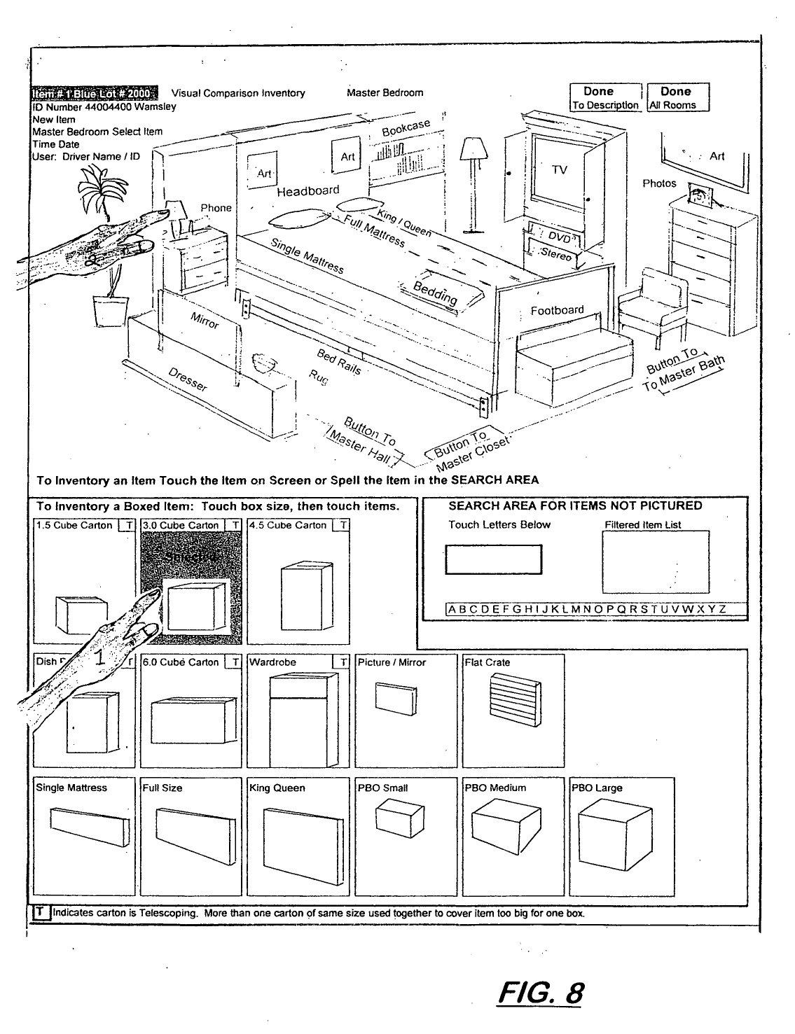

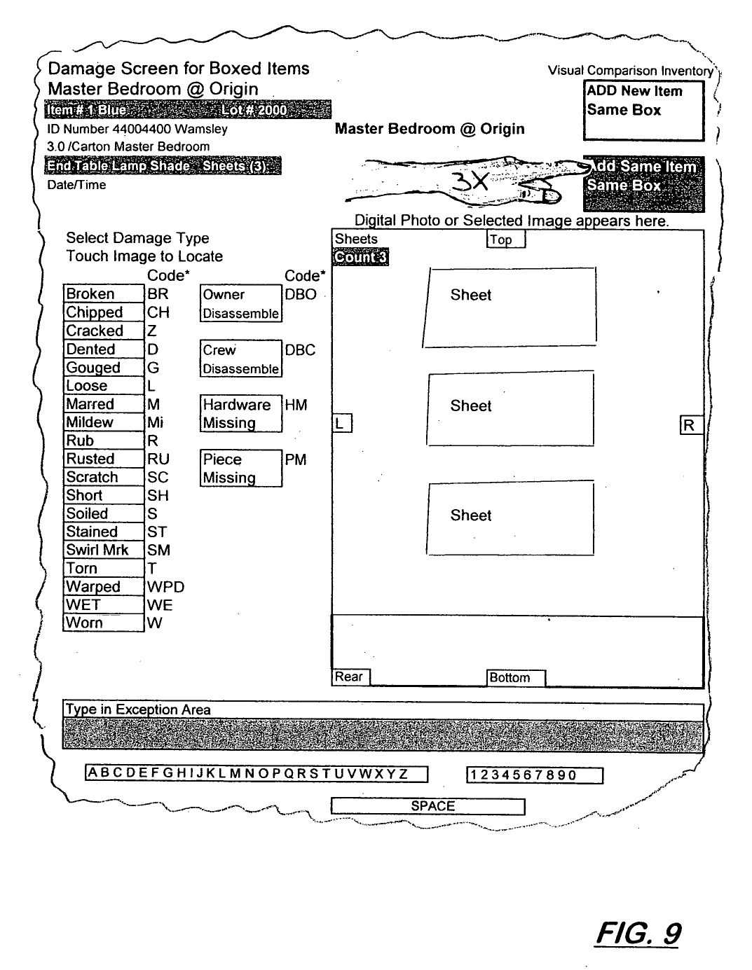

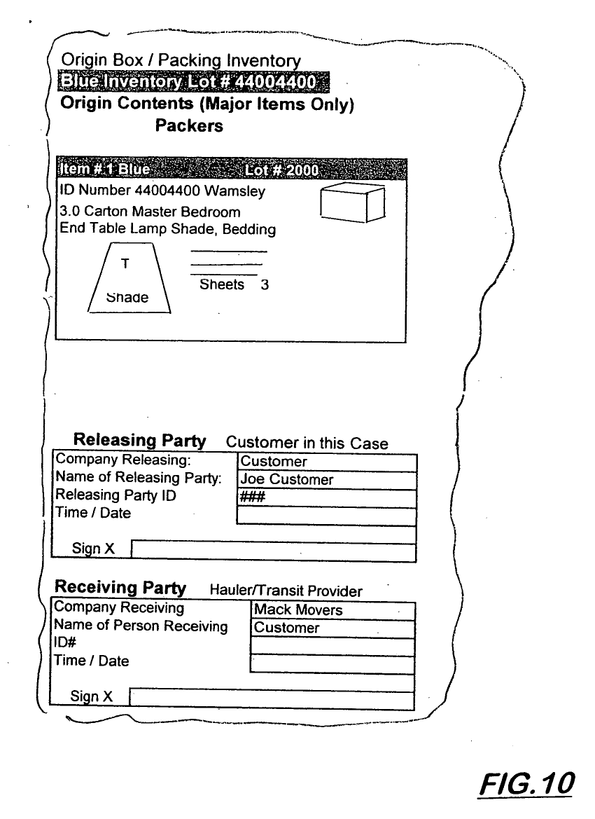

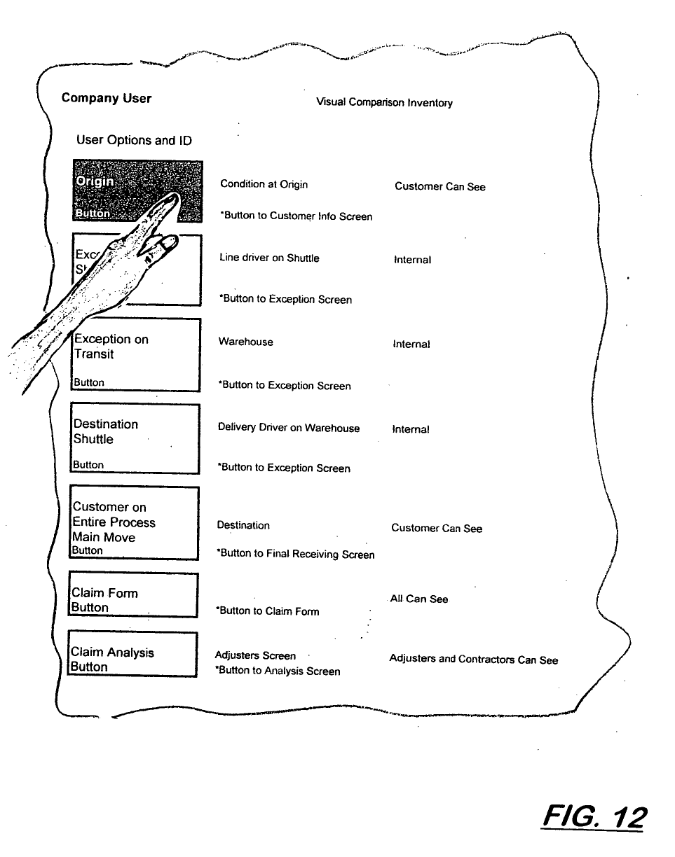

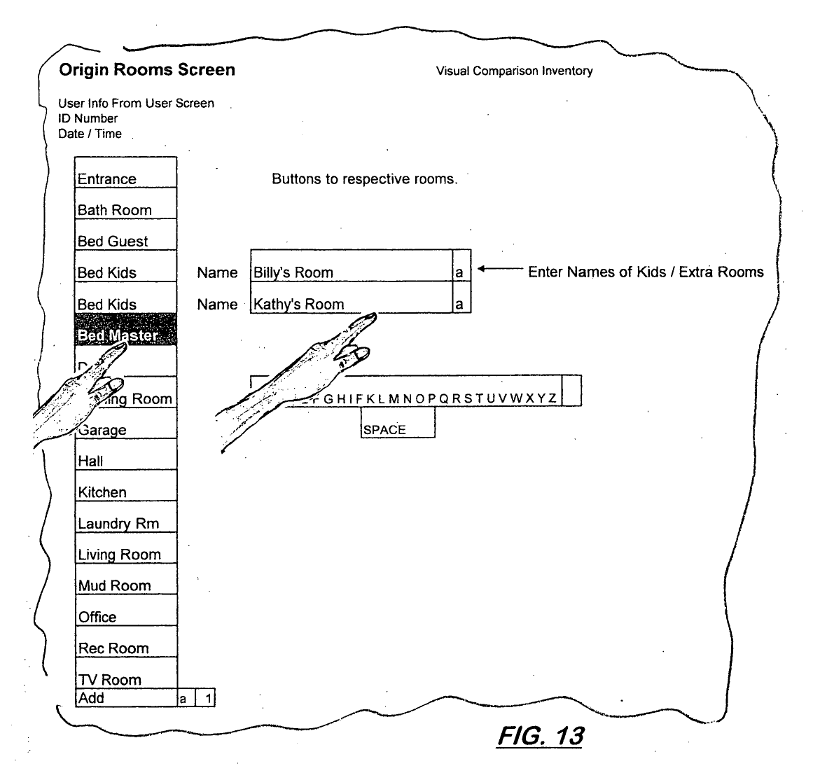

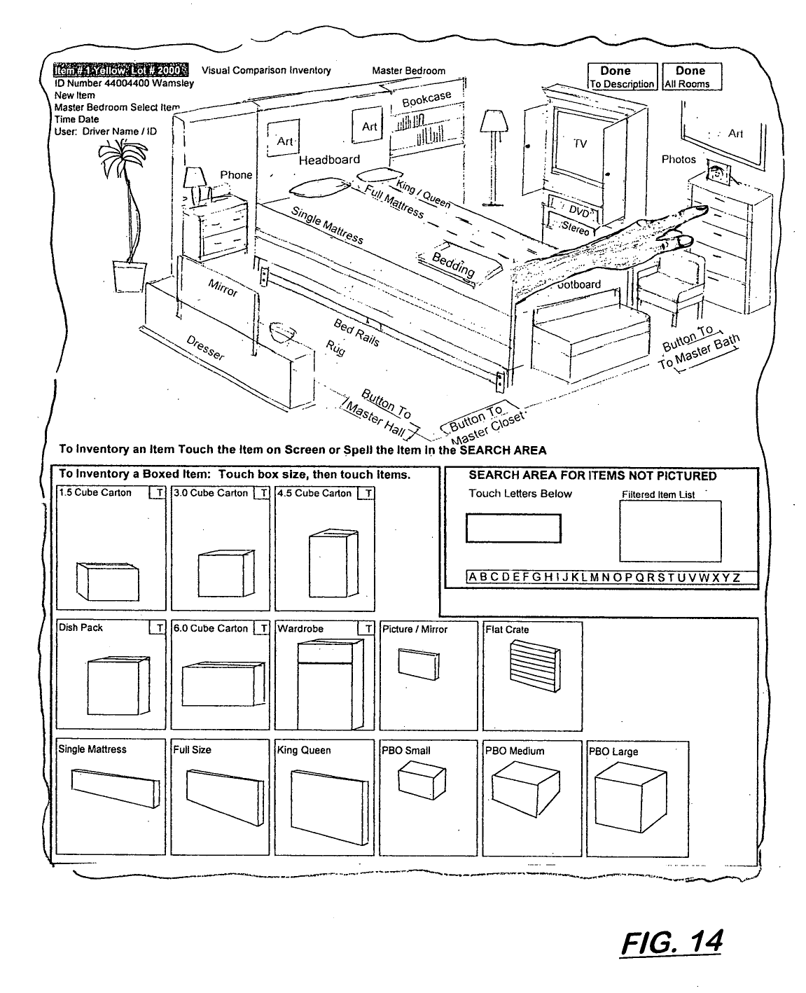

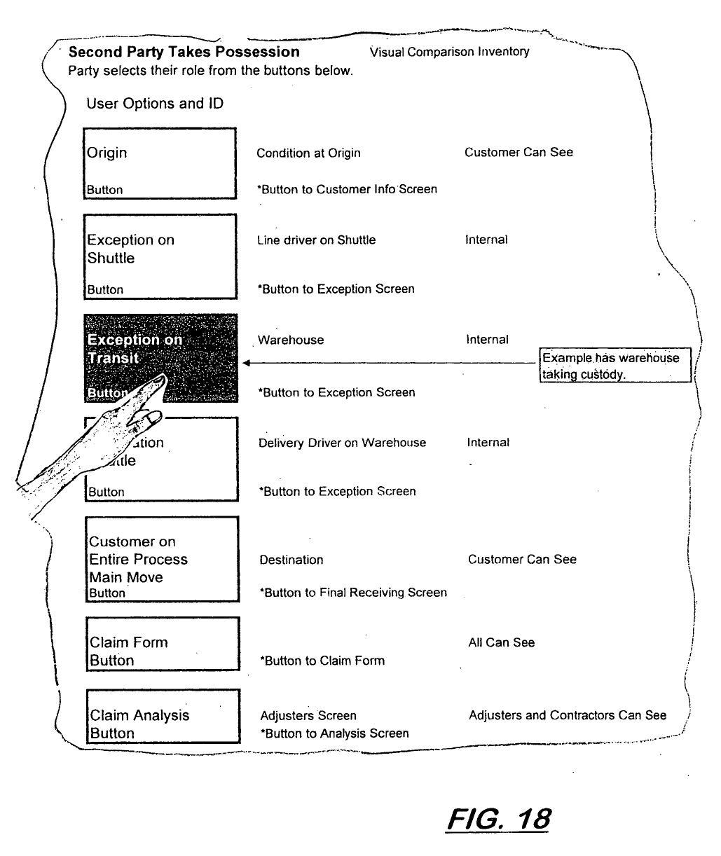

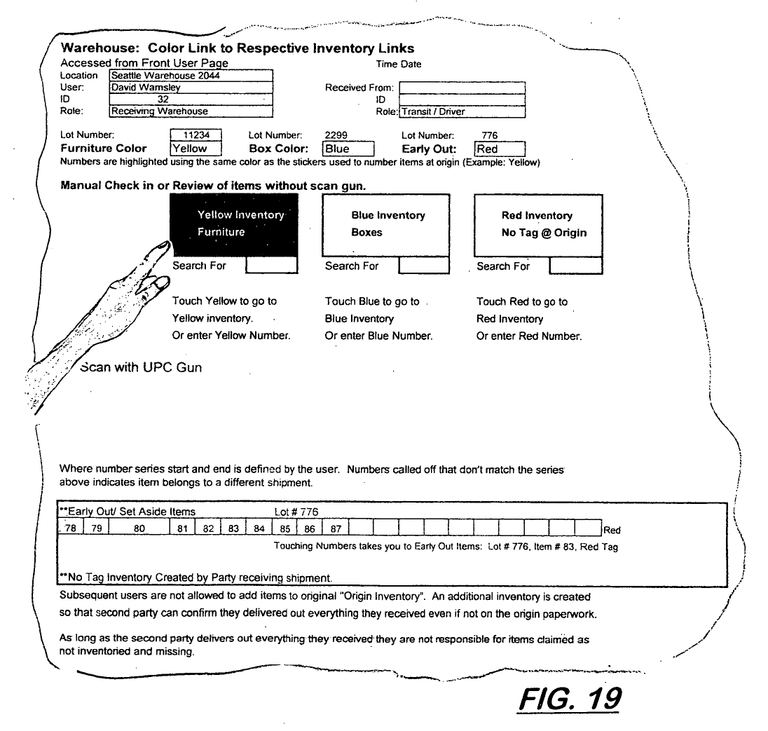

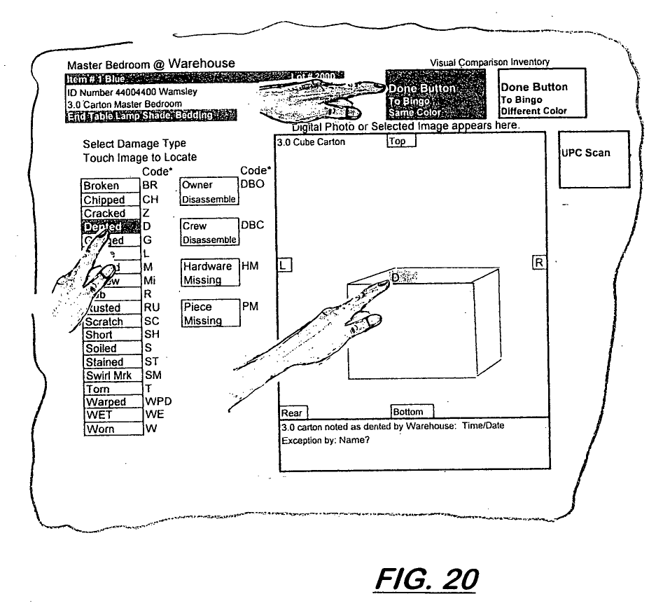

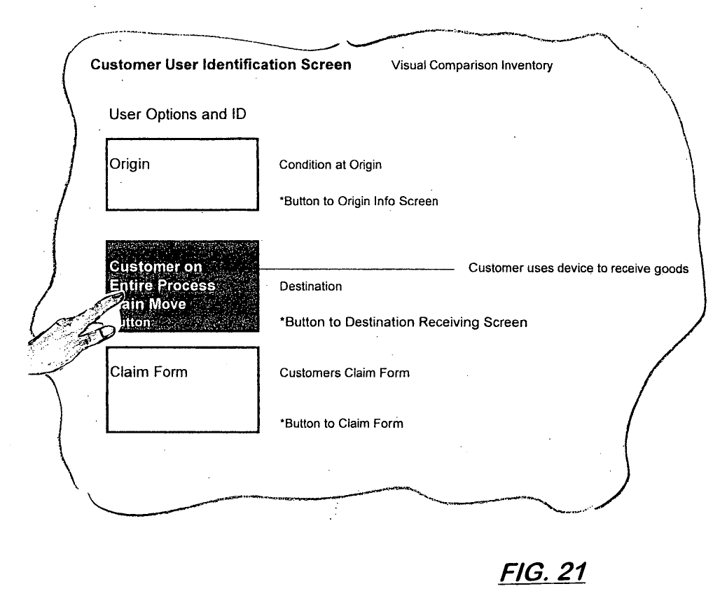

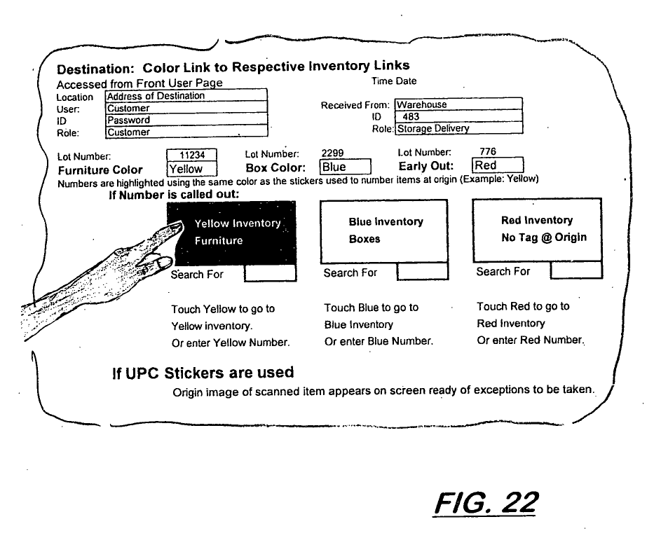

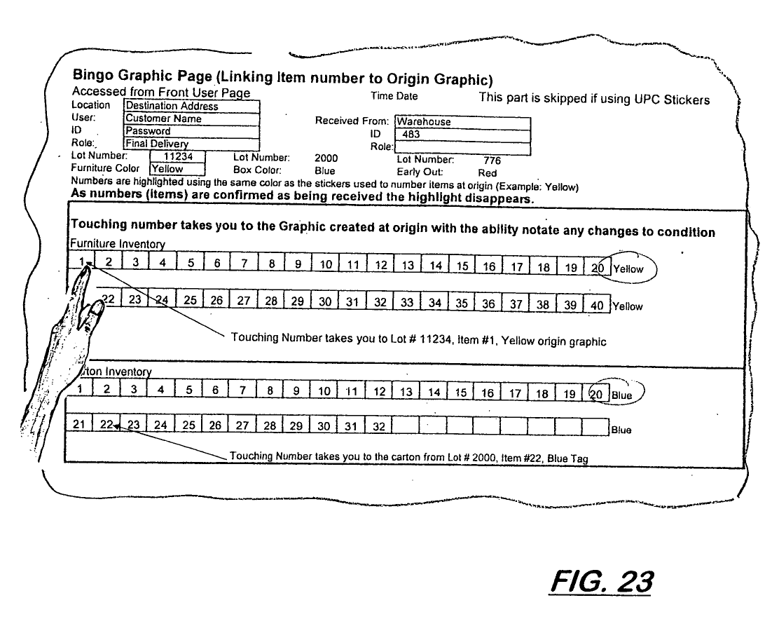

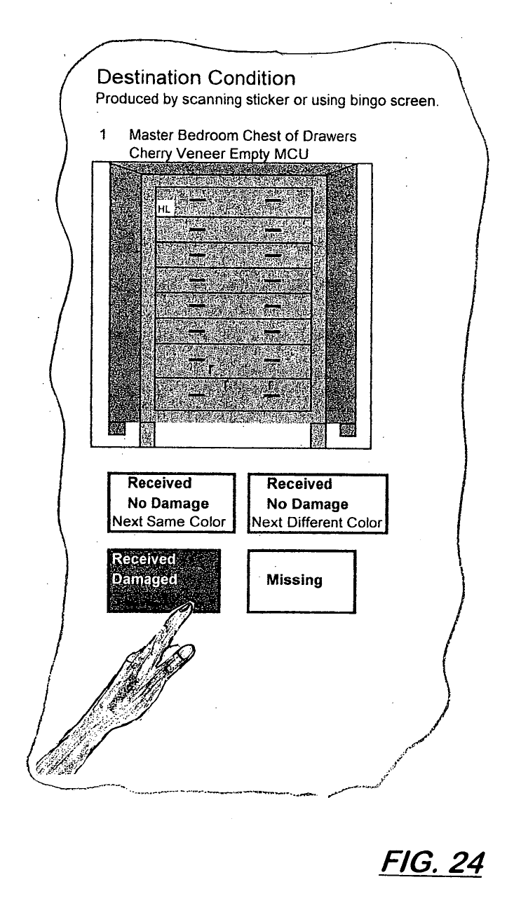

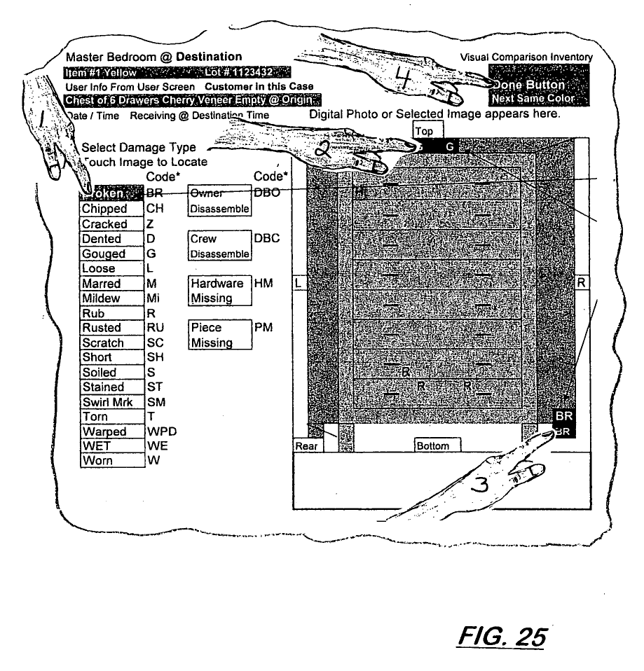

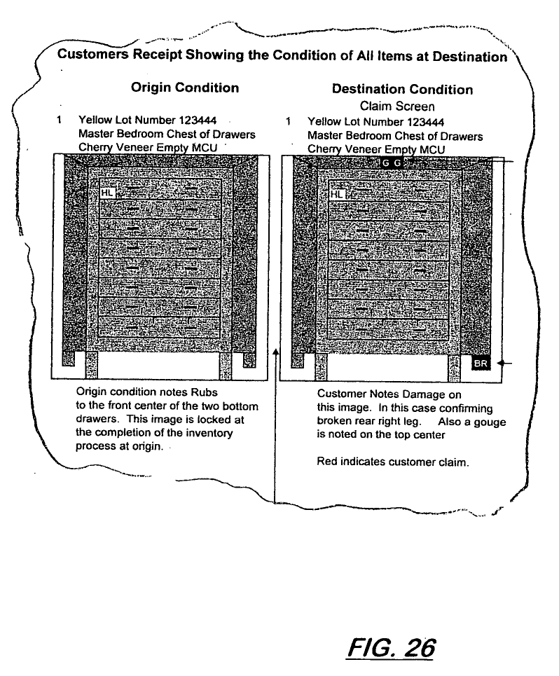

The system 10 uses a portable handheld device 12 first used by a packing company to accurately identify and record the customer's personal property to be packed for moving. As shown in FIG. 1 loaded into the memory 15 of the handheld device 12 is a personal property recording software program 20 that presents different buildings, different room layouts, a list of personal property commonly found in the buildings and images of different pieces of the personal property generally referred as 80. The program 20 presents a series of data entry pages on the device's display/touch screen 13 that are completed by the individual. FIGS. 3-26, present various pages on the display/touch screen 13.

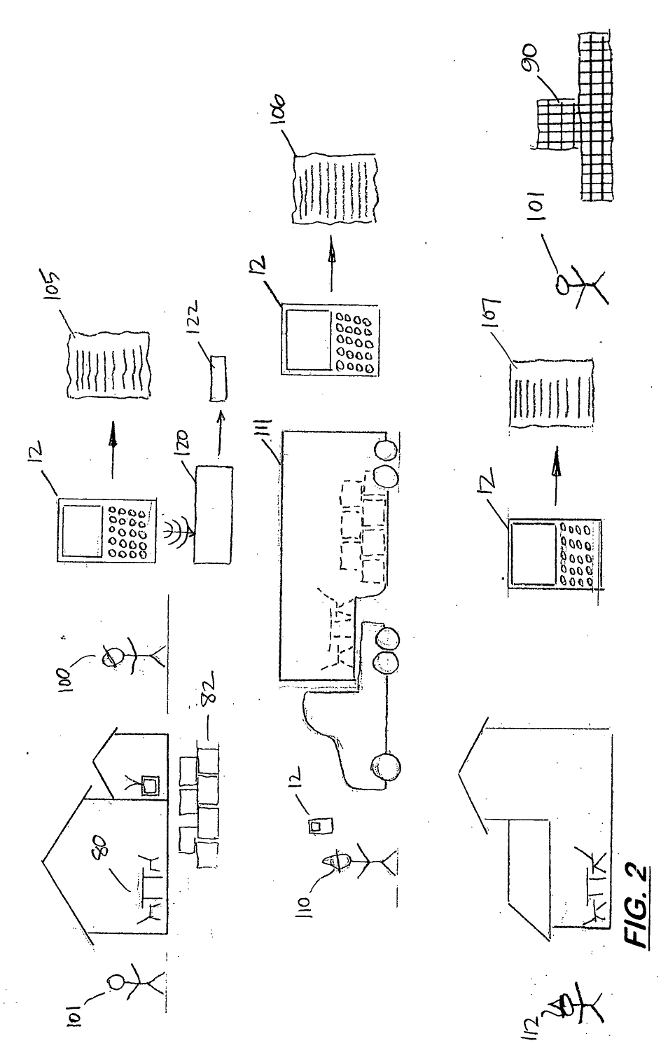

During the packing stage, an identifying code 30 is initially assigned to each piece of personal property 80 or to its outer shipping container 82. When damage is detected on the personal property 80 or to the container 82, the packer designated as 100 in FIG. 2, uses the display/touch screen 13 on the handheld device 12 to record the precise location of the damage on one or more closely representative graphic images of the personal property 80 produced by the software program 20. When the personal property identification and damage recording steps are completed, an originating report 105 is recorded and saved in the memory 15 of the handheld device 12. A printed copy of the originating report 105 is generated and delivered to the customer and the hauler 110. Once the personal property has been verified, the custody of the personal property 80 is considered ‘officially’ transferred to the hauler 110 responsible for transporting the personal property 80 to an intermediate or final destination. The handheld device 12 or the data files 16 store therein contain record information of the personal property 80 is then delivered to the hauler 110.

When the personal property 80 arrives at its intermediate destination, the hauler 110 again inspects the personal property 80 or the shipped containers 82 for lost or damages. When lost or damaged items are found, they are recorded by the hauler 110 on the handheld device 12.

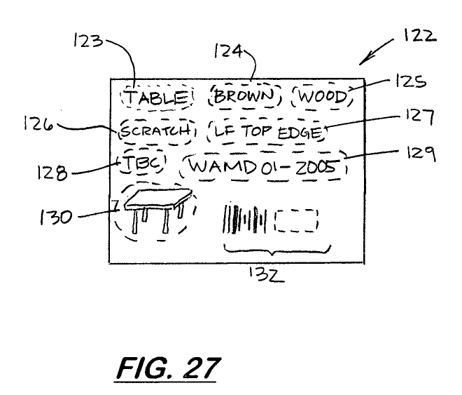

In the preferred embodiment, a portable printing device 120 is provided that generates an adhesive label 122 that is attached to a surface on the personal property 80 or its shipping container 82. As shown in FIG. 27, the label 122 includes the name of the item 123, its color 124, the primary material used to manufacture the item 125, the type of damage 126, the location of the damage 127, the identification of the individual that prepared the label 128, and the customer identification code 129. A generic image 130 of the personal property 80 may also be displayed on the label 122. Also printed or attached to the label 122 is a reading device 132, such as a barcode or an RFID. During the recording process, the identification code 129 of the lost or damaged personal property 80 is entered or scanned or detected by the handheld device 12. The type, color, and material information are then entered. A lost or damage code (scratch) is then entered and the precise location of the damage is recorded on one or more of the images presented to the user on the screen 13. After all of the data is entered into the handheld device 12, the label 122 is then printed.

When all of the personal property 80 has been delivered to its final destination, it is then unloaded by the first hauler or by second hauler who delivers it from the warehouseman. During the unloading process, the hauler 110 checks off the invention as it is removed from the trailer and records its final condition into the handheld device 12. When all of the personal property 80 has been removed from the trailer, a final printed report 107 is then printed and delivered to the customer 101. The customer 101 then inspects the final report 107. If lost or damage items are reported, final reports 107 are delivered to the insurance company 90. The originating and intermediate reports 105, 106 may also be printed and submitted to the insurance company 90. The insurance company 90 then reviews the three forms to determine the responsible company or individual.

The handheld device 12 is a portable battery operated device designed to be carried by a worker 100, 110, 112 as he or she walks through the house or building, through the trailer, and through the warehouse. In the preferred embodiment, shown in FIG. 1, the handheld device 12 includes a display/touch screen 13 and input keys 14 that allows a worker to input data, working memory 15, data files 16 and the software program 20. The printer 120 may also be provided that is used to produce adhesive labels 122. The handheld device 12 and printer 120 may be hard wired or wireless connected together (WIFI or Blue Tooth).

As disclosed above, the software program 20 is designed to expedite the process of accurately recording the personal property and its initial condition and its presence and condition at various stages in the moving process. FIGS.3-26, show a series of screen shots or images of the display/touch screen used by the workers 100, 110, 112 to verify and input data. The software program 20 is designed to help a worker 100, 110, 112 to quickly name the personal property 80 and any associated components or hardward. It is also used to iname and locate damage that exists or that was caused to the personal property 80 during the move.

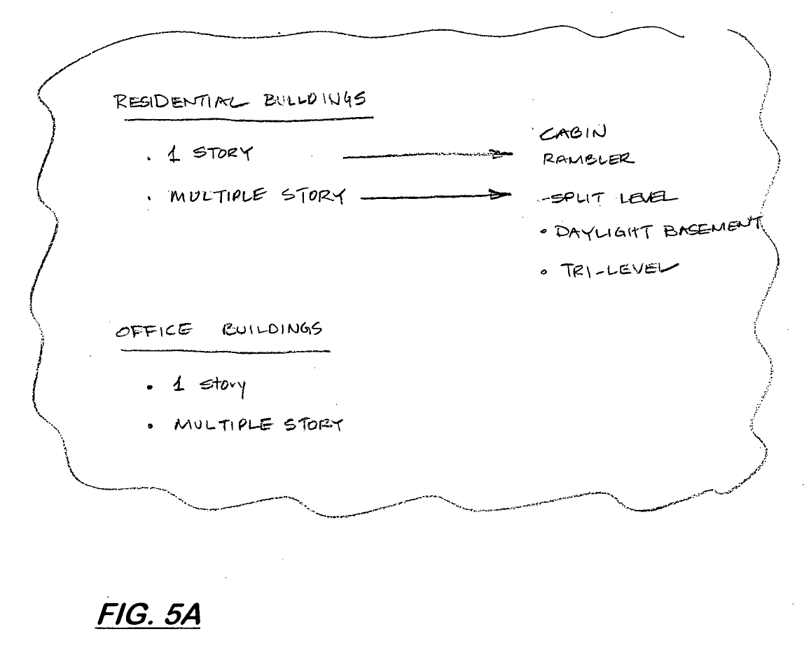

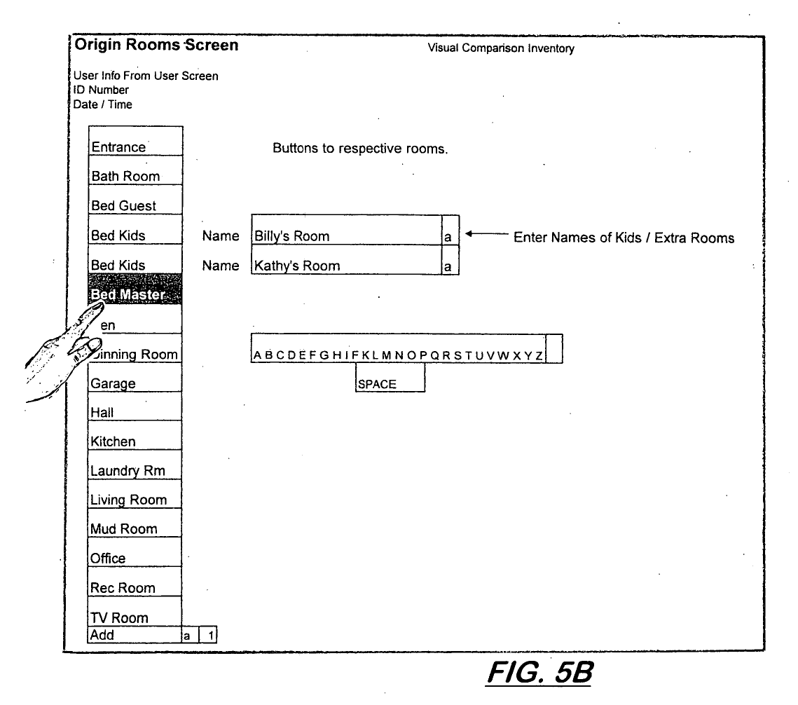

As shown in the accompanying FIG. 5A, when the packer 100 arrives at a originating site, the software program 20 is activated. In one embodiment, an image of different buildings may be presented on the display/touch screen 13. The worker 100, 110, 112 may then select the building closest to the building containing the personal property 80. For example, the building data file may include data for a single story house, a two-story house or a three-story house. Each style of building is associated with a room identification file that generates a list of rooms commonly found in the building selected. The list may be presented on the display/touch screen 13, (see FIG. 5B). For example, if a building is a three-bedroom rambler with an attached three-car garage, the image of such a rambler-style house may be presented and a list of rooms commonly found in the houses may be presented on one side of the screen. The list of rooms may include a living room, a dining room, a kitchen, a formal dining room, a main bathroom, a laundry room, a den, a master bedroom, a master bathroom, a walk-in closet, a first bedroom, a guest bedroom, and the three-car garage. If the building is an office building, the list of rooms may include a main waiting area, a conference room, a library, a mail/copy room, one or more work offices, and a file room.

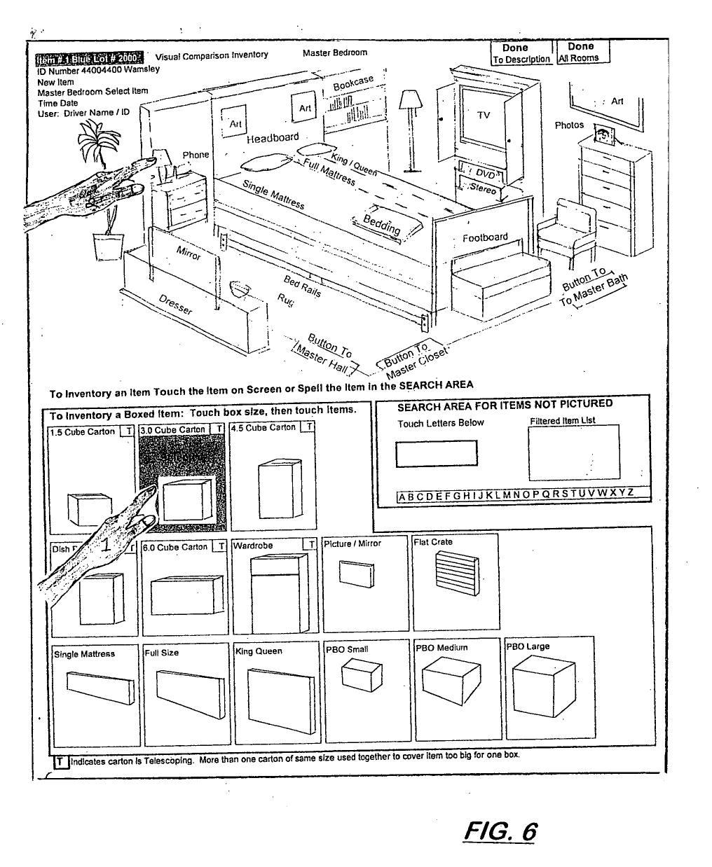

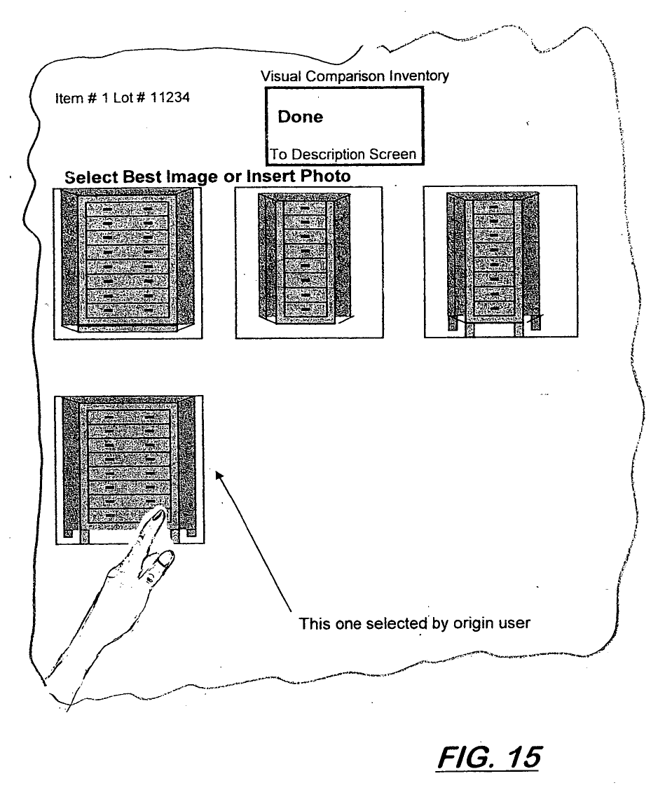

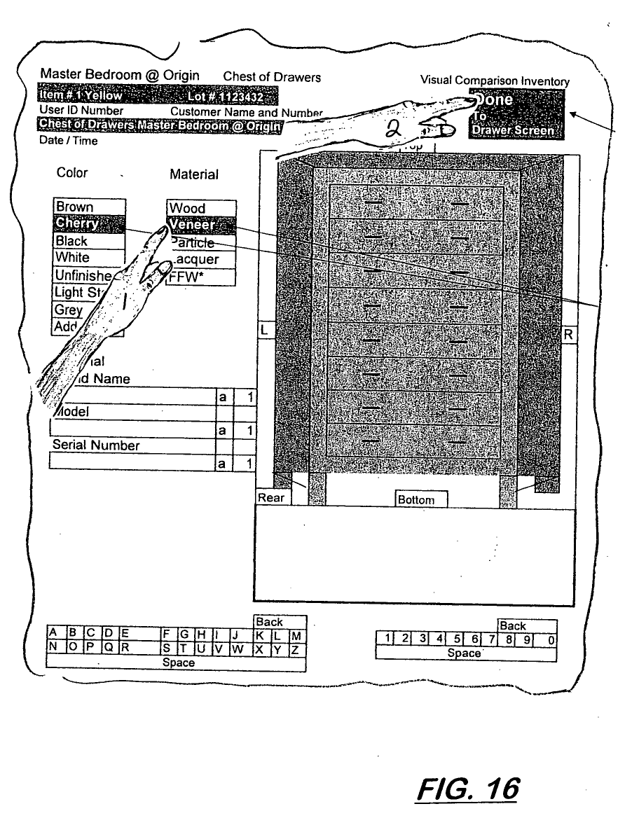

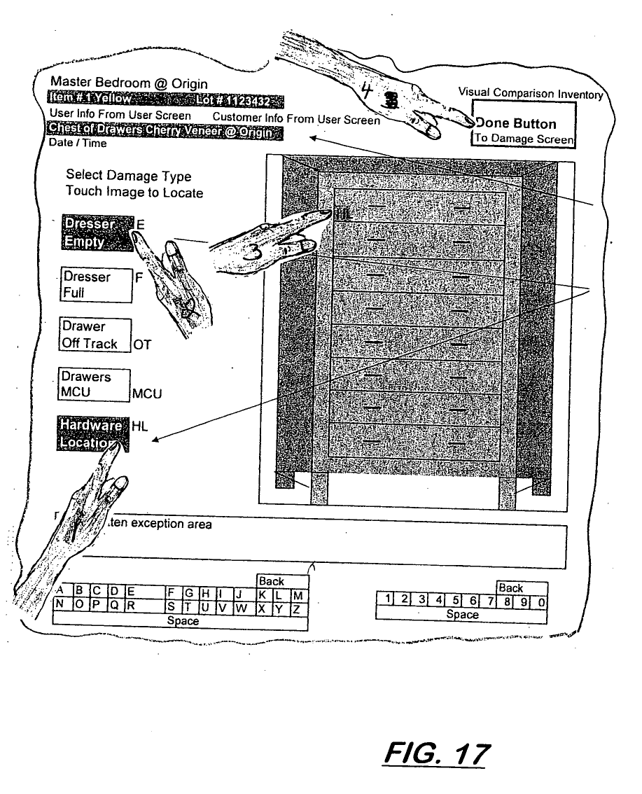

After indicating the type of building, the worker enters the building and selects one of the rooms in the list of rooms that most closely matches the real room. As shown in FIG. 6, when a room is selected, an image of the room is displayed filled with commonly found personal property 80. For example, if the worker enters the house's bedroom, the button for ‘bed room’ is selected on the handheld device 20 and a graphic image of the bedroom is displayed. FIGS. 15-17, are a series of images of a dresser first shown to the worker. (See FIG. 15) Next, the color and type of material used to make the dresser is indicated. (See FIG. 16) FIG. 17 shows the worker indicating the type of damage and its location.

Because some pieces of personal property 80 are made up of separate components or includes hardware that must be disconnected when the personal property 80 is moved, a second menu associated with some personal property 80 may be presented which lists the various components or hardware items. Such second menus typically require the worker to indicate the nature or name of the component or hardware item and the quantity. For example, if a table is selected, the list of components for the table may include a tabletop, four legs, four brackets, set of four nuts, bolts, and two table extensions. The second menu presented may include the following components: nuts, bolts, brackets, pegs, washers, etc.

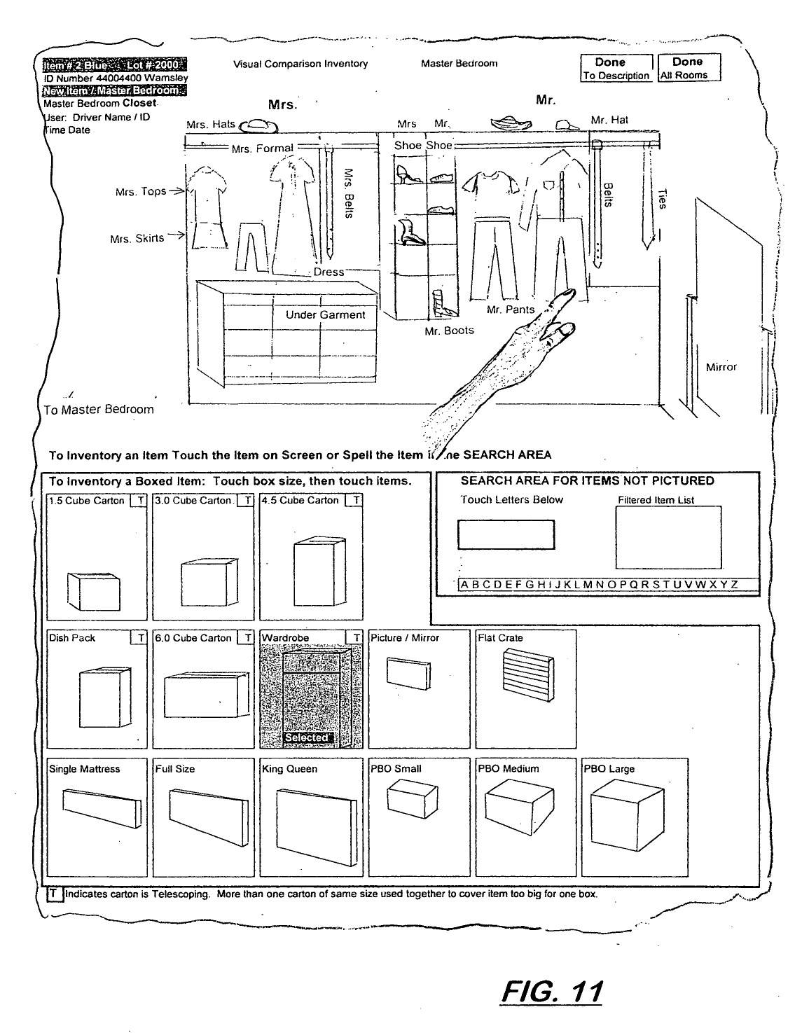

Each piece of personal property 80 and components on the lists includes a set of ‘generic’ graphic files that may be displayed on the handheld device's display/touch screen 13 when selected. When the worker selects a piece of personal property 80 or a component, the software program 20 automatically presents one or more a two-dimensional graphic images of the personal property 80 or the component. (See FIG. 17) If a damage area is to be recorded, the worker then touches the area on the graphic image that corresponds to the location of the damage on the personal property 80 or component. A secondary menu containing a set of damage identification codes identifying the nature of the damage (i.e. scratch, discoloration, chip, dent, warp surface, etc.) may also be provided which is associated with the damage area. The worker would select out of the damage identification codes. FIG. 11 is a display that shows how clothing and personal items are selected and then placed in designated boxes.

Once all of the personal property 80 has been entered into the handheld device 12 and all existing imperfections or damage areas have been identified and recorded, and the personal property 80 has been packed, the originating report 105 may be printed and given to the hauler 110 and to the customer 101. The hauler 110 and customer 101 review the report 105 and inspect the personal property 80 and the shipping containers 82 and verify its existence and condition.

As stated above, during the packing process, an identification label 122 is attached to each piece of personal property 80 and to each shipping container 82. When the shipping container 82 containing several different items, the identication label 122 may include a list of items placed therein.

In some instances, a separate packing company called a packer 100 is used to initially pack and inventory the personal property 80. The hauler 110 may be a separate company that arrives to pick up and loads the personal property 80 onto the trailer 111. The hauler 110 then uses the handheld device 12 to record the identification codes on any lose personal property 80 items and on all shipping containers 82. As the personal property 80 and containers 82 are loaded into the trailer 111, the hauler 110 verifies the condition of the personal property 80 and containers 82 indicated on the originating report 105 and notes any ‘exceptions’. The hauler 110 then prints out an intermediate report 106 and gives it to the packer 100. The hauler 110 then delivers the personal property 80 to an intermediate warehouse or to the final destination. The hauler 110 is normally responsible for unloading the personal property 80 from the trailer 111 into the house or office building. If the hauler transfers custody of the personal property 80 to an intermediate company or individual, such as a warehouse, another intermediate report (not shown) similar to the first intermediate report 106 is printed and given to the receiving party. The receiving party then verifies the information on the report.

As the personal property 80 is removed from the trailer 111, the handheld device 20 is also used to check in the lose personal property 80 items and the shipping containers 82. During this step, the lose items and shipping containers are inspected for any new damage that occurred during transportation. The new damage is then recorded in the handheld device 12, similar to the manner shown in FIG. 17. When all of the personal property 80 has been delivered to the customer 101, a final report 107 is printed and presented to the customer 101.

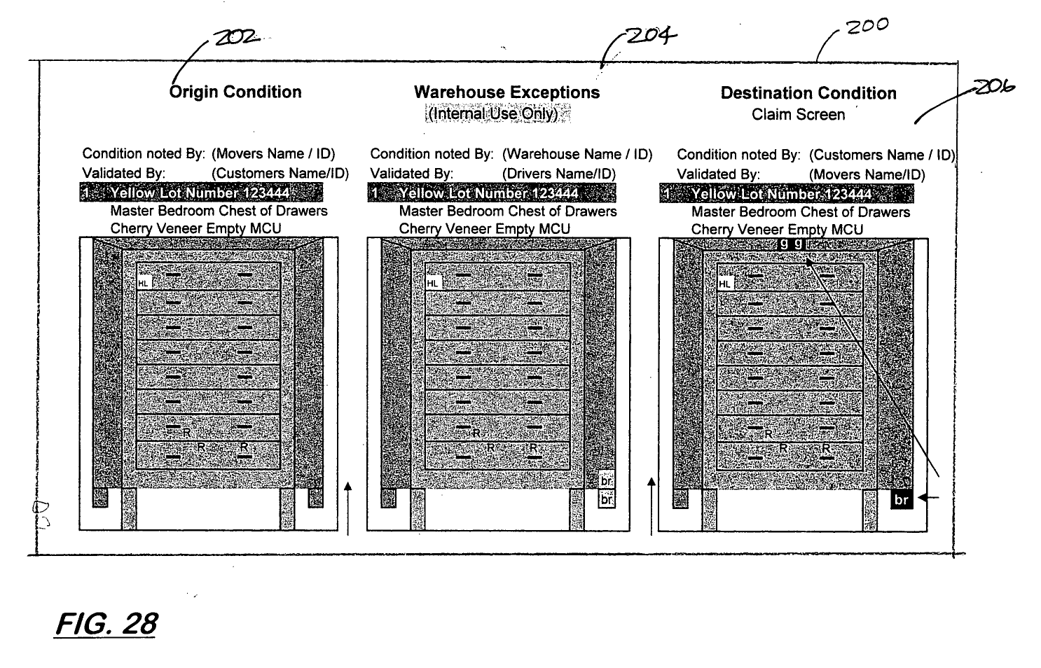

If the customer 101 discovers lost or damaged personal property 80, he or she then files a claim with the insurance company 90. The insurance company 90 obtains a copy of the data file 16 from the handheld device 12 and then reviews the list of items to determine the name of the lost or damage personal property. Once the personal property has been identified, a final report for the personal property is printed out. A representative sample of a final report 200 for a chest of drawers in shown in FIG. 28. The report 200 is divided into three sections: an original condition section 202 that shows the condition of the chest of drawers when custody was taken by the originating haulers with ‘rubs’ noted on the front face of the top drawer; a warehouse exception section 204 wherein a broken right rear leg is recorded; and a destination exception section 206 which indicates a set of gouges is found on the top of the chest of drawers.

Upon inspection of the final report 200, the insurance adjuster can easily and quickly allocate the broken right rear leg to the warehouseman and the two gouges to the destination hauler. No damage is allocated to the original hauler.

In compliance with the statute, the invention described herein has been described in language more or less specific as to structural features. It should be understood, however, that the invention is not limited to the specific features shown, since the means and construction shown is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A graphic driven moving personal property tracking system; comprising:
a. an electronic device, said device includes a display and means for inputting data therein, working memory for operating a personal property software program, and storage memory used for store inputted data, and;
b. a personal property software program loaded into said working memory of said device, said software program capable of presenting a plurality of graphic files capable of being presented to a user on said display on said device, each said graphic file being associated with name, said software program enabling a user to record his or her name and record and indicate the precise location of initial damage to said personal property, said software program also enables subsequent user's to record his or her name and record and indicate the precise of location of damage to said personal property, said record of damage being saved in memory, said software program capable of being used to produce a final report showing the condition of said personal property at different stages of a move.

2. A method for allocating lost or damage personal property by an insurance company, comprising the following steps:
a. selecting a handheld device capable of recording personal property to be moved and its initial condition;
b. inputting data into said handheld device by a packer;
c. printing out a report;
d. reviewing the personal property against the report by a shipper; and,
e. reviewing the personal property against the report by an un-packer.

3. A method for allocating lost or damage personal property by an insurance company comprising the following steps:
a. inspecting a personal property and assigning an identification code to said personal property;
b. assigning a graphic image to said personal property;
c. reviewing said personal property for damages;
d. identifying the name and location of damages on said property;
e recording said identification code, said graphic image, said damage code, and said damage location on said device;
f. repeating steps (c) thru (e) each time the custody of the personal property changes in a move, and;
g. generating a report showing the graphic images of said personal property each time the custody of said personal property changes.
